(19) United States
(12) Patent Application Publication
(10) Pub. No.: US 2016/0159393 A1
(43) Pub. Date: Jun. 9, 2016

(54) ANTI-BIND SLEEVE ADJUSTER FOR STEERING LINKAGE

(71) Applicant: Powers and Sons, LLC, Montpelier, OH (US)

(72) Inventors: Gene Messenger, Novi, MI (US); Matthew Dudeck, Ann Arbor, MI (US); Christopher Fink, Archbold, OH (US); William Heckman, Canton, MI (US); Charles Letts, Ann Arbor, MI (US)

(21) Appl. No.: 14/958,084

(22) Filed: Dec. 3, 2015

Related U.S. Application Data
(60) Provisional application No. 62/123,951, filed on Dec. 5, 2014.

(51) Int. Cl. B62D 7/20; F16B 7/14

(52) U.S. Cl. CPC B62D 7/20; F16B 7/1418

(57) ABSTRACT

An adjustment sleeve for a steering linkage including an external sleeve part having a piston socket and a threaded socket at opposing ends thereof, and an internal sleeve part having a piston and a threaded socket at opposing ends thereof, wherein adjusting rods having ball and stud assemblies are adapted to thread into the threaded sockets, and the piston of the internal sleeve part is rotationally disposed and axially restrained within the piston socket of the external sleeve part such that the external and internal sleeve parts are rotationally decoupled to allow a ball stud to articulate without binding.

### CROSS-REFERENCE TO RELATED APPLICATION

This application claims priority from U.S. Provisional Application No. 62/123,951 filed Dec. 5, 2014, the contents of which are incorporated by reference herein.

### TECHNICAL FIELD AND BACKGROUND OF THE INVENTION

The present invention relates generally to a sleeve for adjusting the length of a steering linkage assembly, and more particularly, to a sleeve configured to rotationally decouple adjusting rods of a steering linkage assembly such that the adjusting rods are able to rotate relative to one another to avoid a binding condition, among other purposes.

A typical steering linkage system includes a series of adjustable length rods required to attain the proper kinematic geometry across vehicles with varying tolerance stack ups. As shown in FIG. 1, an example of a prior art rod assembly 10 (e.g., a drag link) generally includes a first (e.g., left) adjusting rod 12 and a second (e.g., right) adjusting rod 14 connected through an intermediate adjustment sleeve 16. The ends of the first and second adjusting rods 12, 14 are threaded with opposite handed screw threads that thread into opposite ends of the adjustment sleeve 16. In this arrangement, rotating the adjustment sleeve 16 in one direction lengthens the rod assembly 10, and rotating the adjustment sleeve 16 in the opposite direction shortens the rod assembly 10. When the desired length of the rod assembly 10 is achieved, the adjustment sleeve 16 is clamped to each of the first and second adjusting rods 12, 14, thereby locking the overall length of the rod assembly 10.

As shown in FIG. 2, the design intent is that the ball studs 18, which are located proximate the rod ends and connect to mating parts, are each initially angularly centered in their respective socket 20. Relief in the sockets 20 allows the ball studs 18 freedom of angular travel necessary for the suspension kinematic movement. The sockets 20 are typically designed with an allowed over-travel to ensure against binding of the linkage.

As shown in FIG. 3, in the above-described prior art system it is possible to have the first and second adjusting rods 12, 14 misaligned when the clamps 22 are tightened. As shown, this condition restricts the allowable relative angular travel of the ball studs 18. This misalignment can result in a system binding condition and subsequent ball stud failure.

The current solution to avoid misalignment of the adjusting rods 12, 14 is to utilize an alignment device, either as an assembly fixture or as part of the assembly itself. While such a solution can be utilized to align the adjusting rods, at least initially, such a solution is time consuming and adds complexity to an installation. More importantly, if the alignment is not done correctly, the system cannot accommodate for ball stud over-travel which can result in a binding condition and damage to steering and/or suspension components.

### BRIEF SUMMARY OF THE INVENTION

It is therefore an object of the invention to provide a steering linkage assembly in which initial adjusting rod alignment is not critical.

It is another object of the invention to provide a steering linkage assembly in which a ball stud is able to angularly travel regardless of the angular orientation of its respective adjusting rod.

It is another object of the invention to rotationally decouple components of a steering linkage assembly to accommodate component misalignment and ball stud angular travel.

To achieve the foregoing and other objects, in one embodiment the present invention provides an adjustment sleeve for a steering linkage including an external sleeve part having a piston socket and a threaded socket at opposite ends thereof, and an internal sleeve part having a piston and a threaded socket at opposite ends thereof, wherein the piston of the internal sleeve part is rotationally disposed and axially restrained within the piston socket of the external sleeve part.

In another aspect, the adjustment sleeve may include a tubular sleeve bushing disposed between an outer cylindrical wall of the piston and an inner cylindrical wall of the piston socket, the sleeve bushing facilitating rotation of the piston within the piston socket.

In a further aspect, the adjustment sleeve may include a first annular bushing disposed between a first end of the piston and an inner wall of the piston socket, an annular cap disposed in an outer end of the piston socket adapted to resist axial tensile loading, an annular seal disposed within the annular cap and circumferentially surrounding the threaded socket of the internal sleeve part, and a second annular bushing disposed between a second end of the piston and the annular cap, the second annular bushing circumferentially surrounding the threaded socket of the internal sleeve part.

In a further aspect, the piston may be axially restrained within the piston socket between the first annular bushing and the second annular bushing.

In a further aspect, the annular seal may be disposed within an annular recess formed in the annular cap.

In a further aspect, the threaded socket of each of the external sleeve part and the internal sleeve part may be internally screw threaded and adapted to receive an externally screw threaded adjusting rod of a steering linkage assembly.

In a further aspect, the threaded socket of the external sleeve part may have opposite hand internal screw threads of the threaded socket of the internal sleeve part.

In a further aspect, the adjustment sleeve may include a first clamp adapted to lock a first adjusting rod received in the threaded socket of the external sleeve part relative thereto, and a second clamp adapted to lock a second adjusting rod received in the threaded socket of the internal sleeve part relative thereto.

In a further aspect, the internal sleeve part and the external sleeve part may be rotationally decoupled and axially restrained in use.

In another embodiment, the present invention provides a steering linkage assembly including a first adjusting rod having a threaded end opposite a ball stud and socket assembly, a second adjusting rod having a threaded end opposite a ball stud and socket assembly, and an adjustment sleeve disposed between and interconnecting the first and second adjustment rods, the adjustment sleeve including an external sleeve part having a piston socket and a threaded socket at opposite ends thereof, and an internal sleeve part having a piston and a threaded socket at opposite ends thereof, wherein the piston of the internal sleeve part is rotationally disposed and axially restrained within the piston socket of the external sleeve part and wherein the threaded end of the first adjusting rod is threaded into the threaded socket of the external sleeve part and the threaded end of the second adjusting rod is threaded into the threaded socket of the internal sleeve part.

In another aspect, the adjustment sleeve may include a tubular bushing disposed between an outer cylindrical wall of the piston and an inner cylindrical wall of the piston socket, the tubular bushing facilitating rotation of the piston within the piston socket.

In a further aspect, the adjust sleeve may include a first annular bushing disposed between a first end of the piston and an inner wall of the piston socket, an annular cap disposed in an outer end of the piston socket adapted to resist axial tensile loading, an annular seal disposed within the annular cap and circumferentially surrounding the threaded socket of the internal sleeve part, and a second annular bushing disposed between a second end of the piston and the annular cap, the second annular bushing circumferentially surrounding the threaded socket of the internal sleeve part.

In a further aspect, screw threads of the first adjusting rod and the threaded socket of the external sleeve part may be opposite handed threads of screw threads of the second adjusting rod and threaded socket of the internal sleeve part.

In a further aspect, the assembly may include a first clamp adapted to lock the first adjusting rod relative to the threaded socket of the external sleeve part and a second clamp adapted to lock the second adjusting rod relative to the threaded socket of the internal sleeve part.

In a further aspect, ball stud articulation beyond a predetermined maximum may causes the internal sleeve part to rotate relative to the external sleeve part to allow the ball stud to continue articulating without binding the system.

Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 is an isometric view of a prior art rod assembly including a conventional adjustment sleeve;

FIG. 2 shows an angularly centered ball stud of the rod assembly of FIG. 1;

FIG. 3 shows off-center ball stud alignment from misaligned rods of the rod assembly of FIG. 1;

FIG. 4 is an isometric view of an adjustment sleeve according to an embodiment of the invention;

FIG. 5 is an exploded view of the adjustment sleeve of FIG. 4;

FIG. 6 is a longitudinal cross-section of the adjustment sleeve of FIG. 4; and

FIG. 7 is an isometric view of a rod assembly including the adjustment sleeve of FIG. 4.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

Referring to the figures, the present invention provides an anti-bind adjustment sleeve for a steering linkage configured to accommodate ball stud angular travel without binding. While the adjustment mechanism is described with reference to steering linkage, and in particular a drag link assembly, it is envisioned that the mechanisms and concepts for rotationally decoupling components can be applied to other systems within and outside of vehicles.

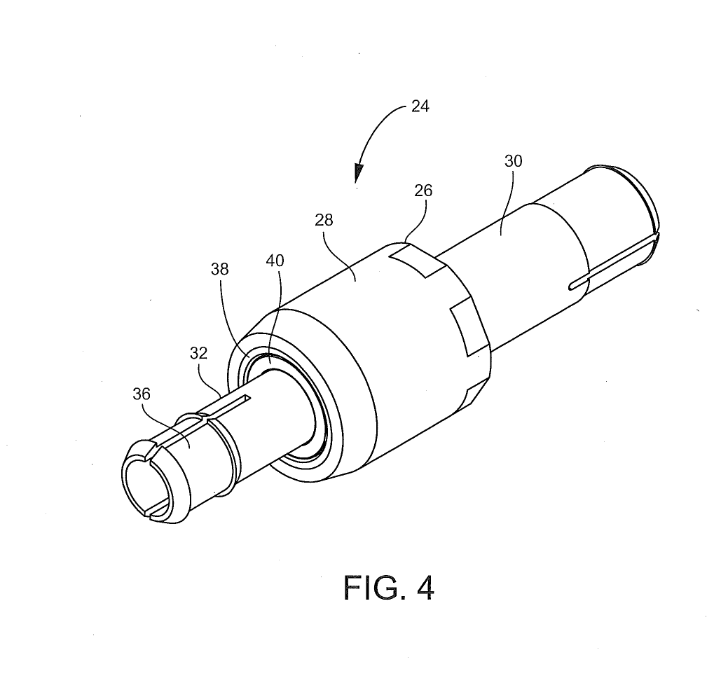

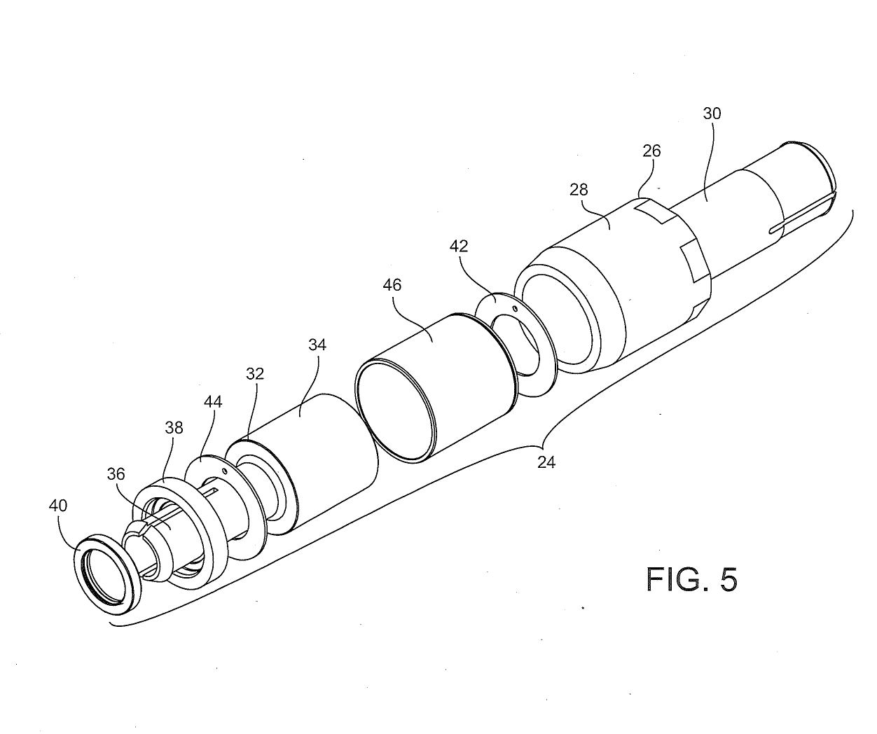

FIG. 4 shows an adjustment sleeve 24 according to a preferred embodiment of the invention. The adjustment sleeve 24 generally includes a first or “external” sleeve part 26 having a piston socket 28 and a threaded socket 30 at opposing ends thereof, and a second or “internal” sleeve part 32 having a piston 34 (see FIG. 5) and a threaded socket 36 at opposing ends thereof. In the assembled configuration, the piston 34 of the internal sleeve part 32 is rotationally disposed and axially restrained within the piston socket 28 of the external sleeve part 26.

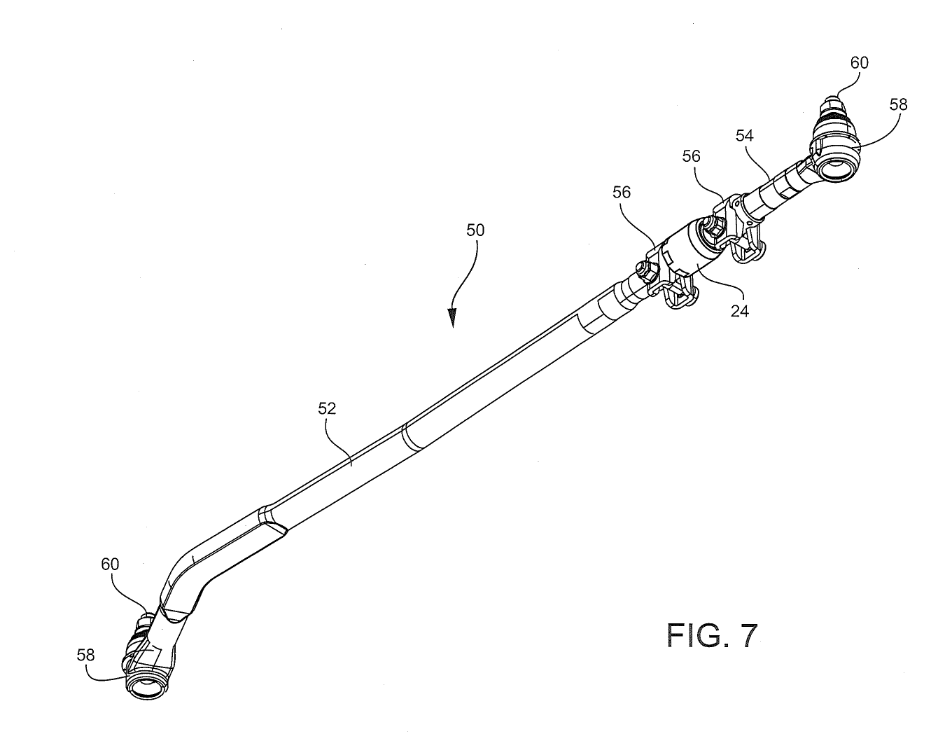

The threaded sockets 30, 36 are internally screw threaded such that left and right, or first and second, externally screw threaded adjusting rods can be threaded into the ends of the adjustment sleeve 24. A portion of the ends of each of the threaded sockets 30, 36 can be longitudinally split or bifurcated such that clamps (see FIG. 7) tightened around the ends of the threaded sockets radially compress the ends to lock the ends around the adjusting rods to prevent relative movement therebetween. The adjusting rods may be advanced into their respective threaded sockets 30, 36 by turning the adjusting rods until a predetermined rod assembly length is achieved, and thereafter the clamps tightened to lock the overall length of the rod assembly. Because the external and internal sleeve parts 26, 32 are rotationally decoupled in use, as discussed in detail below, the external and internal sleeve parts 26, 32 may be restrained during adjusting rod length adjustment such that the adjusting rods and their respective part do not turn together.

A cap 38 is inserted into the open end of the piston socket 28 behind the rotationally disposed piston 34 to prevent axial separation of the external and internal sleeve parts 26, 32. The fit between the cap 38 and inner cylindrical wall of the piston socket 28 is such that axial tensile loading on the assembly 24 does not pull the cap from within the piston socket 28. An annular seal 40 is disposed radially inward of the cap 38 to prevent outside contaminants, debris, fluid, etc. from passing beyond the seal to degrade the internal bushings of the assembly. The annular seal 40 may be made from an elastomeric material and circumferentially surrounds the threaded socket 36 of the internal sleeve part 32 proximate the piston 34.

FIG. 5 is an exploded view of the adjustment sleeve 24, which generally includes the external and internal sleeve parts 26, 32, cap 38, annular seal 40, first and second annular bushings 42, 44, and sleeve bushing 46. The sleeve bushing 46 is a tubular bushing that circumferentially surrounds the piston 34. The sleeve bushing 46 is disposed in and occupies an annular space between the outer cylindrical wall of the piston 34 an inner cylindrical wall of the piston socket 28, and has a length generally equal to or equal to the length of the piston 34. The sleeve bushing 46 functions to separate the piston 34 and piston socket 28 to permit relative rotation therebetween, as well as minimize friction between the two parts.

The piston 34 and the sleeve bushing 46 are disposed between the first and second annular bushings 42, 44. In the assembled configuration, the first annular bushing 42 is disposed against the “forward” face of the piston 34 in a space between the end of the piston and the inner wall or “bottom” of the piston socket 28. While an annular ring is shown, the first bushing 42 may also have a disc shape. The second bushing 44 is disposed against the “rear” face of the piston 34 in a space between the piston 34 and cap 38. The second annular bushing is an annular ring in order to accommodate the threaded socket 36 of the internal sleeve part 32 received therethrough. The piston 34 is thus substantially surrounded on the ends and circumference thereof by bushings which space the piston 34 from the inner walls of the piston socket 28 and cap 28 to facilitate rotational movement and reduce friction therebetween.

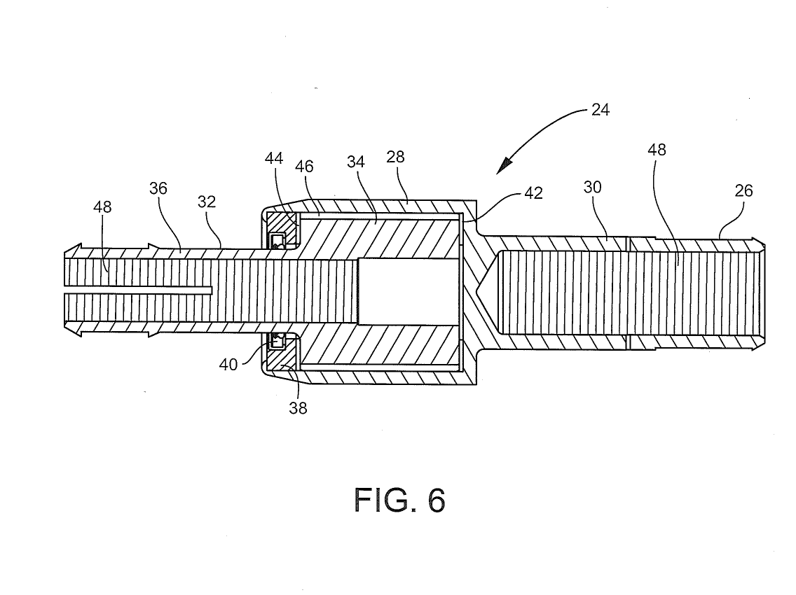

As shown in FIG. 6, in the assembled configuration, the piston 34, sleeve bushing 46, first and second annular bushings 42, 44, annular cap 38 and annular seal 40 are all housed and retained within the piston socket 28 in an arrangement such that axial movement between the piston 34 and piston socket 28 is restrained and rotational movement therebetween is permitted. The annular seal 40 may be disposed within a recess formed in the outer face of the the annular cap 38 thereby positioning the annular seal 40 in contact with the threaded socket 36 of the internal sleeve part 32. Such an arrangement prevents outside contaminants from reaching the bushings 42, 44, 46, while maintaining axial alignment of the external and internal sleeve parts 26, 32.

FIG. 6 also shows the internal screw threads 48 of the threaded sockets 30, 36. The threaded sockets 30, 36 may have opposite handed screw threads. For example, the threaded socket 30 of the external sleeve part 26 may have right-handed screws threads, while the threaded socket 36 of the internal sleeve part 32 may have left-handed screw threads, and vice-versa. In this arrangement, rotating the adjustment sleeve 24 in one direction brings the adjusting rods closer together, thereby shortening the overall length of the rod assembly, while rotating the adjustment sleeve 24 in the opposite direction drives the adjusting rods apart, thereby lengthening the overall rod assembly. As stated above, the external and internal sleeve parts 26, 32 may be restrained against relative rotational movement during assembly length adjustment.

In an alternative embodiment, the threaded sockets 30, 36 may lack internal threading and otherwise engage the adjusting rods inserted therein. In an alternative embodiment, one of the adjusting rods may be fixed to one of the external and internal sleeve parts 26, 32, while the other adjusting rod may be adjustable relative to its respective sleeve part.

FIG. 7 shows the adjustment sleeve 24 as part of a steering linkage assembly 50 generally including the adjustment sleeve 24, first adjusting rod 52, second adjusting rod 54, clamps 56, and ball stud assemblies 58 each including a ball stud 60. In a specific embodiment, the assembly 50 may be a drag link assembly, which is a component of a steering linkage of a vehicle. In a particular steering linkage arrangement, the steering linkage assembly 50 may connect at one end to a pitman arm and at the opposing end to a tie rod assembly. Drag link attachment points can include ball joint assemblies for providing free kinematic motion.

The adjustment sleeve 24 is positioned along the length of the assembly 50 between the first and second adjusting rods 52, 54. The adjusting rods 52, 54 can be advanced into or withdrawn from the adjustment sleeve 24 to adjust the overall length of the assembly 50. The clamps 56 are tightened around the threaded sockets to lock each of the adjusting rods 52, 54 relative to their respective socket to fix the overall length of the assembly 50. As compared to a conventional adjustment sleeve which couples and rotationally fixes the adjusting rods, the present adjustment sleeve 24 rotationally decouples the adjusting rods 52, 54, thereby allowing the internal sleeve part to rotate relative to the external sleeve part to accommodate adjusting rod misalignment and ball stud angular travel.

When the adjusting rods 52, 54 are “misaligned” and/or an adjusting rod misaligned (e.g., off-center) relative to its respect ball stud and ball stud articulation contacts the adjusting rod, the rotationally decoupled adjusting rod is free to rotate, thereby allowing the ball stud to continue to articulate without binding. In other words, the ball stud 60 is allowed to articulate without being restrained by the angular orientation of the adjusting rod. “Misalignment” of the adjusting rod is accommodated by the free rotation of the respective external or internal sleeve part 26, 32 to which the adjusting rod is connected.

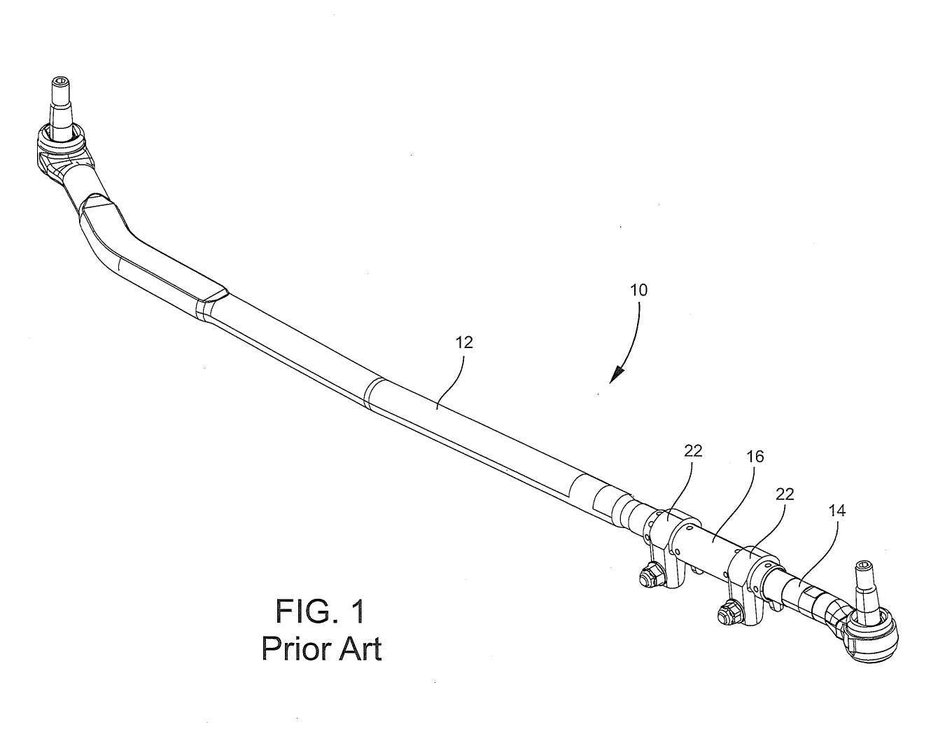

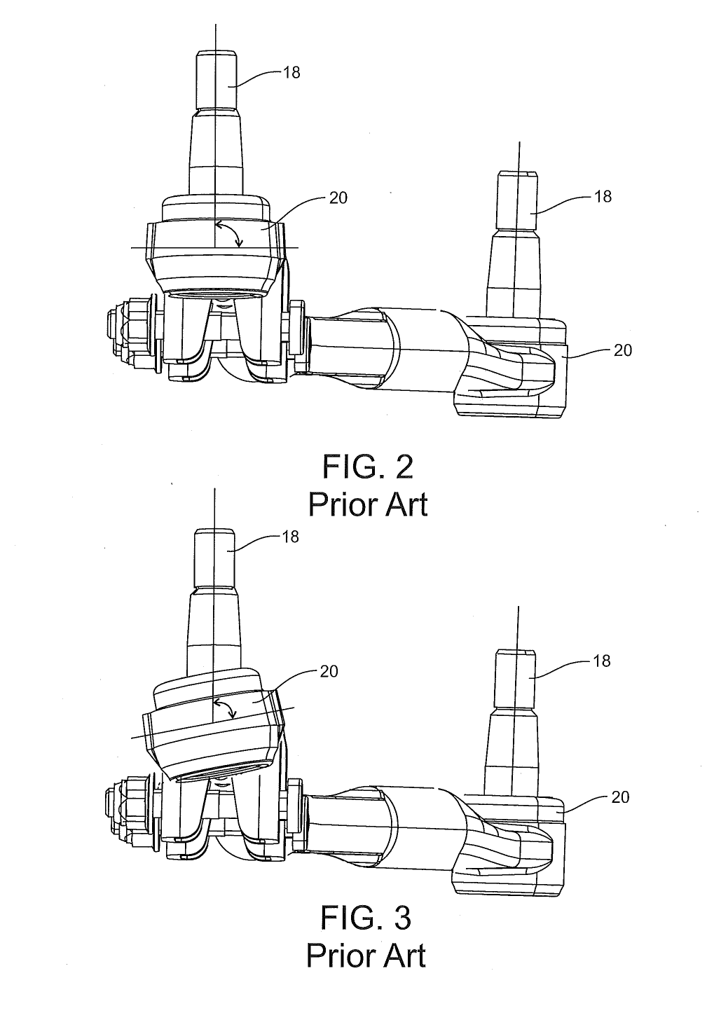

The steering linkage assembly 50 may be provided as a complete assembly including the adjustment sleeve 24 for original equipment and retrofit applications. In another application, the adjustment sleeve 24 be may be provided as a replacement assembly for a conventional adjustment sleeve. As evident comparing FIGS. 1 and 7, a conventional adjustment sleeve and the adjustment sleeve 24 of the present invention are similarly sized, thus the present adjustment sleeve 24 is packaged and dimensioned to fit within the confines of space allocated to the steering linkage in a vehicle.

While the foregoing description provides embodiments of the invention by way of example, it is envisioned that other embodiments may perform similar functions and/or achieve similar results. Any and all such equivalent embodiments and examples are within the scope of the present invention and are intended to be covered by the appended claims.

What is claimed is:

1. An adjustment sleeve for a steering linkage, comprising:
an external sleeve part having a piston socket and a threaded socket at opposite ends thereof; and
an internal sleeve part having a piston and a threaded socket at opposite ends thereof;
wherein the piston of the internal sleeve part is rotationally disposed and axially restrained within the piston socket of the external sleeve part.

2. The adjustment sleeve of claim 1, further comprising a sleeve bushing disposed between an outer cylindrical wall of the piston and an inner cylindrical wall of the piston socket, the sleeve bushing facilitating rotation of the piston within the piston socket.

3. The adjustment sleeve of claim 1, further comprising:
a first annular bushing disposed between a first end of the piston and an inner wall of the piston socket;
an annular cap disposed in an outer end of the piston socket adapted to resist axial tensile loading;
an annular seal disposed within the annular cap and circumferentially surrounding the threaded socket of the internal sleeve part; and
a second annular bushing disposed between a second end of the piston and the annular cap, the second annular bushing circumferentially surrounding the threaded socket of the internal sleeve part.

4. The adjustment sleeve of claim 3, wherein the piston is axially restrained within the piston socket between the first annular bushing and the second annular bushing.

5. The adjustment sleeve of claim 3, wherein the annular seal is disposed within an annular recess formed in the annular cap.

6. The adjustment sleeve of claim 1, wherein the threaded socket of each of the external sleeve part and the internal sleeve part is internally screw threaded and adapted to receive an externally screw threaded adjusting rod of a steering linkage assembly.

7. The adjustment sleeve of claim 1, wherein the threaded socket of the external sleeve part has opposite hand internal screw threads of the threaded socket of the internal sleeve part.

8. The adjustment sleeve of claim 1, further comprising a first clamp adapted to lock a first adjusting rod received in the threaded socket of the external sleeve part relative thereto, and a second clamp adapted to lock a second adjusting rod received in the threaded socket of the internal sleeve part relative thereto.

9. The adjustment sleeve of claim 1, wherein the internal sleeve part and the external sleeve part are rotationally decoupled and axially restrained in use.

10. A steering linkage assembly, comprising:
a first adjusting rod having a threaded end opposite a ball stud and socket assembly;
a second adjusting rod having a threaded end opposite a ball stud and socket assembly; and
an adjustment sleeve disposed between and interconnecting the first and second adjustment rods, the adjustment sleeve comprising an external sleeve part having a piston socket and a threaded socket at opposite ends thereof, and an internal sleeve part having a piston and a threaded socket at opposite ends thereof, wherein the piston of the internal sleeve part is rotationally disposed and axially restrained within the piston socket of the external sleeve part; and
wherein the threaded end of the first adjusting rod is threaded into the threaded socket of the external sleeve part and the threaded end of the second adjusting rod is threaded into the threaded socket of the internal sleeve part.

11. The steering linkage assembly of claim 10, wherein the adjustment sleeve further comprises a sleeve bushing disposed between an outer cylindrical wall of the piston and an inner cylindrical wall of the piston socket, the sleeve bushing facilitating rotation of the piston within the piston socket.

12. The steering linkage assembly of claim 10, wherein the adjustment sleeve further comprises:
a first annular bushing disposed between a first end of the piston and an inner wall of the piston socket;
an annular cap disposed in an outer end of the piston socket adapted to resist axial tensile loading;
an annular seal disposed within the annular cap and circumferentially surrounding the threaded socket of the internal sleeve part; and
a second annular bushing disposed between a second end of the piston and the annular cap, the second annular bushing circumferentially surrounding the threaded socket of the internal sleeve part.

13. The steering linkage assembly of claim 12, wherein the piston is axially restrained within the piston socket between the first annular bushing and the second annular bushing.

14. The steering linkage assembly of claim 12, wherein the annular seal is disposed within an annular recess formed in the annular cap.

15. The steering linkage assembly of claim 10, wherein screw threads of the first adjusting rod and the threaded socket of the external sleeve part are opposite handed threads of screw threads of the second adjusting rod and threaded socket of the internal sleeve part.

16. The steering linkage assembly of claim 10, further comprising a first clamp adapted to lock the first adjusting rod relative to the threaded socket of the external sleeve part and a second clamp adapted to lock the second adjusting rod relative to the threaded socket of the internal sleeve part.

17. The steering linkage assembly of claim 10, wherein ball stud articulation beyond a predetermined maximum causes the internal sleeve part to rotate relative to the external sleeve part to allow the ball stud to continue articulating without binding.
